(19) United States
(12) Patent Application Publication
(10) Pub. No.: US 2002/0038312 A1
(43) Pub. Date: Mar. 28, 2002

(54) Encryption program and method for conducting merge/purge of mailing lists

(76) Inventors: Matthew G. Donner, Fair Lawn, NJ (US); Stephen Golub, Ft. Lee, NJ (US)

Correspondence Address: WEINGRAM & ASSOCIATES P.C., P.O. BOX 927, 197 W. SPRING VALLEY AVENUE, MAYWOOD, NJ, 07607, US

(21) Appl. No.: 09/874,934

(22) Filed: Jun. 6, 2001

Related U.S. Application Data
(60) Provisional application No. 60/213,760, filed on Jun. 23, 2000.

(51) Int. Cl. G06F 17/30

(52) U.S. Cl. 707/200

(57) ABSTRACT

A unique merge/purge system for eliminating duplicate mailings particularly used with electronic mail, or email, employs a computer software program and algorithm to encrypt the basic information into match codes and identification numbers prior to being supplied to the merge/purge operation. The merge/purge operation is conducted with the encrypted lists returned to the owner or maintainer of the lists. The maintainer uses the information and matched codes to transmit mailings to the purged lists of names and addresses. The system provides improved security without undesired release of the list owners email addresses.

### CROSS-REFERENCE TO RELATED APPLICATIONS

This application claims the benefit of U.S. Provisional Application No. 60/213,760, filed Jun. 23, 2000.

### BACKGROUND OF THE INVENTION

1. Field of the Invention

This invention relates to mail order list management and, more specifically, to email merge/purge processes to reduce and eliminate duplicate listings and mailings.

In direct marketing, mailers, such as catalog companies, use many different mailing lists from different sources for their marketing campaigns. Since the profiles of many of these lists are similar, people that appear on one list often appear on one or more of the other lists they are using for the same campaign.

Mailers do not want to send multiple catalogs to the same person as it is a waste of money (printing, postage, etc.). There is a process called a merge/purge, which is done to identify and eliminate the duplicates between these lists.

These merge/purges are usually done by data processing centers with specialized software. The steps required for a standard merge/purge are shown in FIG. 1 and described below.

2. Description of the Prior Art

1. Individual lists are ordered from their respective List Owners 10. For example, J. Crew as the mailer would order LL Bean's mailing list from LL Bean. These lists, containing names, street addresses and sometimes telephone numbers, are usually maintained by an outside data processing center known as a Service Bureau 12. These service bureaus provide the lists 14 to the merge/purge facility specified by the mailer.

2. The Merge/Purge company 16 receives the lists from the Service Bureaus and performs a number of processes on them:

A) Reformat/Assign Keys—The data on each of the files is rearranged into a standard format and unique alphanumeric codes are assigned to each file. These codes are specified by the mailer and are used to track the results of each list throughout the merge/purge, mailing and response cycles.

B) Address Standardization—This process standardizes and corrects the addresses of the records on the file. For example, 23 N. Main Street; 23 north Main St.; and 23 N. Main St. would all be converted to 23 North Main Street. This allows duplicates to be identified properly in the merge/purge process.

C) Match Code Assignment—The names and addresses that appear on the lists are converted, using an algorithm defined by the merge/purge facility, to an alphanumeric string which will be used to represent the record in the merge/purge. For example:

John Smith

b 1243 Central Avenue

Des Moines, Iowa 50344

would be assigned the match code: 50344JSMTH1243. This match code is comprised of the following:

Zip Code

First Initial of First Name

First Four Consonants of Last Name

First Four Numbers of Street Address

This allows for duplicates to be identified in a merge/purge, even when slight variations exist between the same person appearing on multiple lists. For example, John Smith, J Smith and John A. Smith may all be the same person, but if a character for character match were done, they would all be considered different people. By using match codes, the records would all be correctly identified as the same person.

It is important to note that match codes are not reversible. In other words, by providing the match code for John Smith in the example above, even knowing the algorithm used to create the match code, there would be no way of figuring out, from the match code alone, the original address from which it was created.

It is also important to note that different merge/purge facilities use their own proprietary match code algorithms. There is no established industry standard.

D) Merge/Purge—After the match codes have been assigned to all of the input records, the files are combined, duplicates are identified by their match codes and removed. The end result is a single file which contains all the data from the input files with no duplication.

E) Final Output Processing—After the merge/purge is done, and the duplicates have been eliminated, the combined, unduplicated files undergo final processing. This often includes a postal presort which allows the mailer to receive the lowest possible postage rate and often includes the reformatting of the file into a format requested by the lettershop where the merged file will be sent.

3. The lettershop 18 selected by the mailer, receives the merge/purge output and does the mailing on behalf of the mailer. This involves printing the names and addresses on the catalogs or mail pieces and arranging for transport to a postal facility.

This is essentially how merge/purge has worked for many years and is still the standard process for mailers who use multiple lists. Cumulatively, hundreds of millions of dollars are spent annually on merge/purge processing.

Examples of known systems employing merge/purge processes for eliminating duplicate mailing list information are shown in the following patents.

U.S. Pat. No. 5,111,395 to Smith et al concerns an automated system for soliciting fund contributions where customer lists are created with a merge/purge program that avoids sending of duplicate solicitation letters. A computer program employs match codes of names and addresses to identify duplicate records which are eliminated.

U.S. Pat. No. 5,303,149 to Janigian concerns a method for creating mailing lists using a merge/purge program that identifies duplicate records even if key elements of names and addresses differ.

### OBJECTS AND SUMMARY OF THE INVENTION

The present invention provides a method of conducting merge/purge operations on several mailing lists which includes the use of a computer program and algorithm to encrypt the basic information into match codes with identification numbers prior to being provided to the merge/purge organization. It then conducts the merge/purge and then returns the encrypted lists back to the original owner. This enables the original owner, while using the conversion factors involved in the original match codes, to send the corrected and merge/purge lists for direct mail or email broadcast. The computer program includes an algorithm to assign match codes which uses various factors in an email address to produce a two-part match code which gives a high degree of accuracy for the merge/purge system.

Accordingly, it is an object of the present invention to provide a method for conducting merge/purge which is secure, easily usable for email as well as direct mail, which does not require disclosure of information by a mailing list holder and which can work with several different mailing lists without having to share any information between the various list holders.

It is another object of the present invention to provide a method for conducting merge/purge which provides a means for the list owners or service bureaus to provide the match codes so that all information provided to the merge/purge entity will be secure.

It is another object of the present invention to provide a computer program for assigning match codes and identification numbers for use by merge/purge without requiring knowledge of the raw data.

It is another object of the present invention to provide a novel algorithm for assigning unique match codes for greater merge/purge efficiency.

It is an added object of the present invention to provide an improved merge/purge system for email marketing.

It is another object of the present invention to provide a unique email merge/purge system for eliminating duplicate email messages from the same mailer to the same person and address.

Another object of the invention is to create multiple output files which are returned to the list owner or service bureau to send the email on behalf of the mailer.

A further object of the invention is to transmit the input files with duplicates removed back to the list owner or service bureau with the present software to match back the unduplicated match codes to the original names and email addresses from which they were created for use by the list owner/service bureau to transmit for the mailer.

### BRIEF DESCRIPTION OF THE DRAWINGS

For a more complete understanding of the present invention reference may be had to the following drawings taken in connection with the description of the preferred embodiments, of which:

FIG. 1 is a system block diagram of the prior art showing the method for producing or conducting merge/purge operations in connection with sorting of mailing lists and sending out of letters.

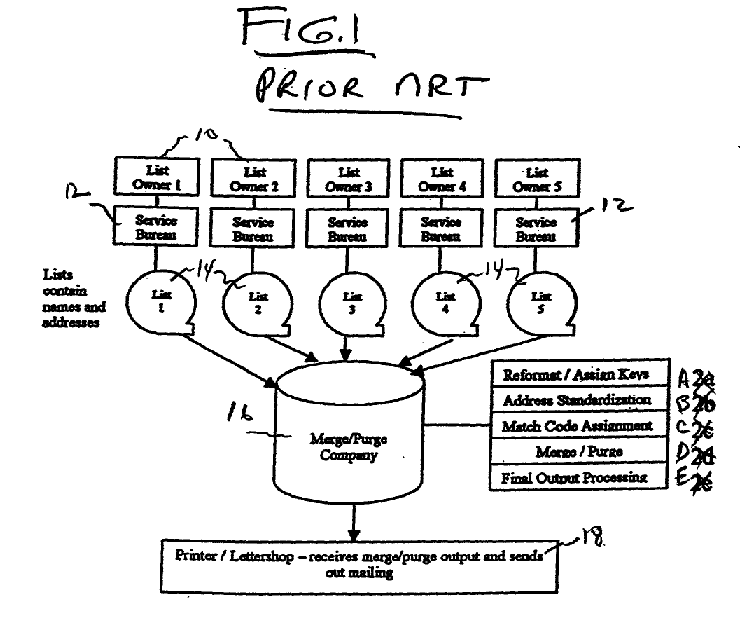

FIG. 2 is a system block diagram showing the method of the present invention of processing information from list holders and passing them through the merge/purge process, returning the processed information and then broadcasting the processed addresses via email and/or direct mail.

### DETAILED DESCRIPTION OF THE PREFERRED EMBODIMENTS

In the recent past, marketing via email, as opposed to postal mail, has increased dramatically among traditional direct marketers. The industry is growing exponentially, and many experts predict that it will steadily continue to grow in popularity and start to replace direct mail as the message delivery method of choice. Email marketing is expected to be a $6 billion industry within several years.

There are several major obstacles to the growth of this industry that are preventing many mailers from making as rapid a transition to email marketing as they would if these obstacles did not exist. The main obstacle, and the one which this invention addresses, is the lack of a standard merge/purge system for email addresses.

Unlike in direct mail, email list owners will not allow their lists to be given to a third party for merge/purge processing. This is a nearly universal policy across several thousand separate list owners. The reasons for this are:

1. Concern about the possible misuse of email addresses, were they to fall into the wrong hands.

2. Lack of effective monitoring tools. With direct mail, it is relatively easy to insert decoy addresses in a mailing list being used in a merge/purge to monitor and prevent misuse of the names. For technical reasons, this is far more difficult with email lists, which is a cause for concern about misuse.

3. For legal reasons, the email message must be delivered by the list owner on behalf of the mailer, and not by the mailer itself.

4. The usual email lists contain only Name and Email Address, no street address.

There are several companies that currently offer email merge/purge services. However, because there are few if any list owners that will release their email addresses for merge/purge, very few mailers can take advantage of this service. When email merge/purge is done, duplicates are usually identified by doing a hard match, email to email.

The demand for email merge/purge is enormous and is growing rapidly. Because of the sensitivity of consumers to receiving unwanted email, merge/purge is even more critical to email marketing than it is to direct marketing. Multiple email messages from the same mailer sent to the same person will result in lower response rates for the mailer, and will irritate consumers causing them to request that their names be removed from mailing lists and they not be sent future messages. This harms all parties, mailers as well as list owners.

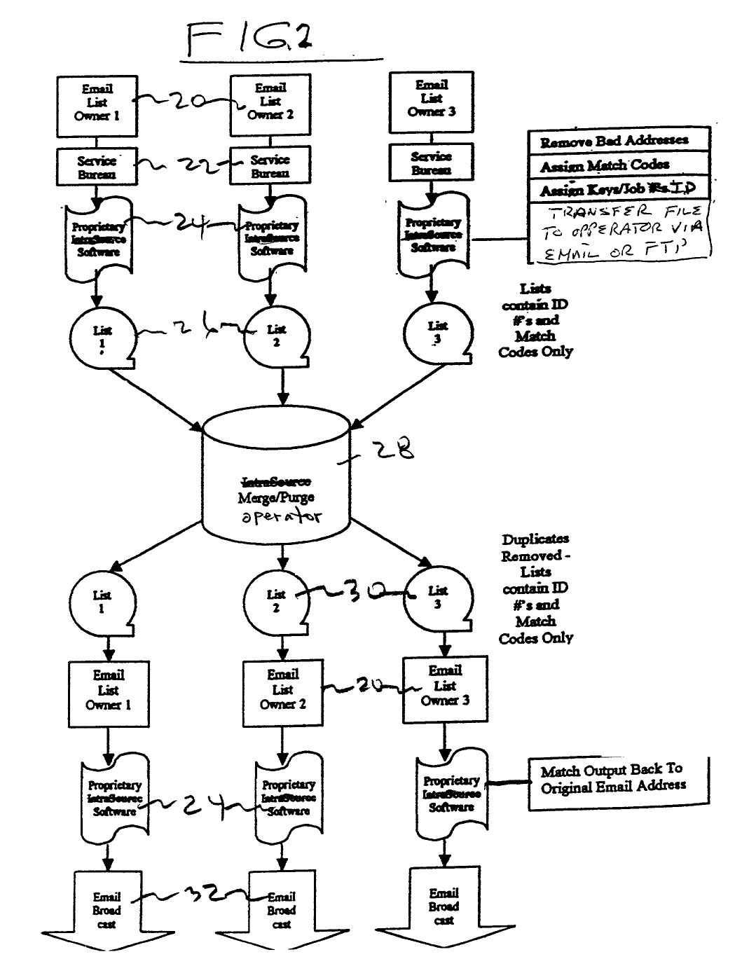

The present Email Merge/purge system addresses all of these issues. Referring to FIG. 2, the email merge/purge works as follows.

1. List owners 20 have their email lists maintained at service bureaus 22, which specialize in list maintenance, and often do email transmissions as well.

a. List owners and their respective service bureaus are given, at no cost, the present proprietary email merge/purge software 24 which performs the following functions:

i. Remove invalid addresses: email addresses that do not conform to the standard formatting scheme are removed.

ii. Match code Assignment: using a unique match code algorithm integrated into the present software, match codes are assigned to all of the records to be used in the merge/purge. The original record, which contains just a name and email address, will now contain the name, the email address, and a match code.

iii. All of the records on the file that are submitted for merge/purge are assigned a unique “key code” job identification number to identify the source of the record in the merge/purge.

iv. Merge Input data is transmitted, via FTP (File Transfer Protocall) or email, to the present operator for merge/purge processing. The data transmitted from lists 26 contains match Codes and Key Codes/Identification Numbers (ID#'S) only. No actual email addresses will leave the possession of the list owner/service bureau.

The operator 28 receives input files from all of the input sources and performs merge/purge based solely on the Match Codes and identification numbers that have been assigned by the present software. In many cases, the mailer's own customer file will be included in the merge/purge as a suppression file, meaning that existing customers would be omitted from prospective email campaigns. The present software will be used to assign match codes to these suppression files, as well.

After the merge/purge is complete, the input files, lists 30, with the duplicates removed, are transmitted back, via FTP or email, to the original list owners/service bureaus or maintainers 20.

Once the list owners/service bureaus receive the files, the present software 24 will match back the unduplicated match codes to the original names and email addresses from which they were created. These purged names and email addresses would then be used by the list owner/service bureau and transmitted, or broadcast 32, on behalf of the mailer.

### MATCH CODE ALGORITHM

The match code algorithm integrated into the merge/purge software works as follows:

The algorithm produces a number for each email address, this number has two parts. The first part follows:

Part I:

a) for every character of the email address obtain its ASCII value, the term ASCII being a known standard computer format.

example: A=65, B=66, C=67, . . . M=77, . . . T=84, . . .

b) divide the ASCII value by the character position in the entire string.

example: MAT equals 77, 65, 84.

77/1+65/2+84/3 . . .

c) store the first six decimal positions. example: 123.987654

Part II:

a) for every character of the email address its ASCII value is obtained.

example: A=65, B=66, C=67, . . .

b) take the current number and divide by number+1

example: FORM A/B+B/C+C/D+. . .

A=65, B=66, C=67, D=68, E=69, F=70 . . .

65/66+66/67+67/68+68/69+69/70+. . .

c) store the first six decimal positions.

example: 123.987654 then 987654

FINAL:

Combine: Part I and II

If part i equals 987654 and if part II equals 123456, then final answer +987654123456.

Str_section 1=Mid(Str (dbl)_prior), InStr(Str(dbl_prior), “.”)+1, 6)

The actual algorithm written in visual basic 6 is as follows.

′ SECTION: Sum by ASCII Value in the EMail divided by its position.
′

If (int_error_indicator = False) Then

dbl_prior = 0
str_cmc “”
str_cmc = UCase Mid (str_irecord, intEmailpos, intEmaillen)
For int_loop = 1 To Len(Trim(str_cmc))

dbl_currentvalue = 0
dbl_currentvalue = Asc(Mid(str_cmc, int_loop, 1)) / int_loop
dbl_prior = dbl_prior + dbl_currentvalue

Next
′str_section1 = Mid(Str(dbl_prior) + “.000000”, InStr(Str(dbl_prior), “.”) + 1, 6)
str_section1 = Mid(Mid(Str(dbl_prior), InStr(Str(dbl_prior), “.”) + 1, 6) + “00000

0”, 1, 6)
′ SECTION: Sum the series a/b + b/c + c/d . . .
′

int_numerator = 0
dbl_prior = 0
int_numerator = Asc(Mid(str_cmc, 1, 1))
For int_loop = 2 To Len(Trim(str_cmc))

dbl_currentvalue = 0
dbl_currentvalue = int_numerator / Asc(Mid(str_cmc, int_loop, 1))
dbl_prior = dbl_prior + dbl_currentvalue
int_numerator = Asc(Mid(str_cmc, int_loop, 1))

Next

′str_section2 = Mid(Str(dbl_prior) + “.000000”, InStr(Str(dbl_prior), “.”) + 1, 6)
str_section2 = Mid(Mid(Str(dbl_prior), InStr(Str(dbl_prior), “.”) + 1, 6) + “00000

0”, 1, 6)
′SECTION: Build Output Record.

str_orecord = “”
str_orecord = str_orecord & Mid(str_section1 & str_section2 & Space(12), 1, 12)
str_orecord = str_orecord & Mid(str_irecord, intPINpos, intPINlen)
If (intKeypos > 0 Or intKeylen > 0) Then

str_orecord = str_orecord & Mid(Mid(str_irecord, intKeypos, intKeylen) & Space(1

2), 1, 12)

Else

str_orecord = str_orecord & Space(12)

End If
str_orecord = str_orecord & Mid(frmEncipher.txtjobno..Text & Space(8), 1, 8)
str_orecord = str_orecord & “X”
Print #2, str_orecord
frmEncipher.txtocount.Text = frmEncipher.txtocount.Text + 1

Else

Print #3, str_irecord

End If

### KEY DIFFERENCES/DISTINCTIONS

There are several very important ways in which the present email merge/purge process differs from standard postal address and email address merge/purge processing:

1) Match codes are assigned by list owner/service bureau using the present software, not by the merge/purge facility. This is the most important feature. In standard merge/purge, the merge/purge facility would use their own proprietary match code algorithm to assign match codes. In order for the merge/purge to work, all of the input files must have their match codes assigned using the same algorithm.

2) Actual address data never leaves possession of the list owner/service bureau. In standard merge/purge, whether it be postal or email addresses, the actual address data is given to the merge/purge facility where the match codes are assigned. The present process allows the list owners/service bureaus to assign the match codes, using a unique standardized algorithm, making it unnecessary for actual address data to be given to the merge/purge facility.

3) Multiple output files are created. In a standard merge/purge, the objective is to create a single, unduplicated output file, which can then be given to a lettershop for mailing. The present system creates multiple output files which are returned to the original list owners/service bureaus. This allows the list owners/service bureaus to perform the email broadcasting on behalf of the mailer.

The present unique email merge/purge process is an entirely new approach which provides list owners with 100% data protection.

It will be understood that the embodiments described herein are merely exemplary and that a person skilled in the art may make many variations and modifications without departing from the spirit and scope of the invention. All such modifications and variations are intended to be included within the scope of the invention as defined in the appended claims.

What is claimed is:

1. A merge/purge system for eliminating duplicate mailings from maintainers of lists of names and addresses comprising:
processing the lists from each maintainer through a computer software program which establishes a standard format to remove nonconforming addresses,
applying a match code algorithm from said software to assign a match code to each record of names and addresses on each list,
applying a key code identification number from said software to identify the source of each record,
transmitting the processed recorded data containing only match and identification codes representative of each record to a central merge/purge processing operation,
processing the coded recorded data through the merge/purge operation to remove duplicate information based only upon the match and identification codes and provide purged output lists data,
retransmitting the purged recorded output lists data back to the lists maintainers,
processing the purged output data to match back unduplicated match codes to the original lists of names and addresses, and
transmitting mailings from the list maintainers to the purged lists of names and addresses.

2. The system of claim 1 wherein the addresses are email addresses.

3. The system of claim 2 wherein the match code algorithm produces a number for each email address, the number having two parts.

4. The system of claim 3 wherein the first part of said number is produced by obtaining the ASCII value for each character of the email address, dividing the ASCII value by the character position in the entire string of characters, and storing the first six decimal positions.

5. The system of claim 4 wherein the second part of said number is produced by obtaining the ASCII value for each character of the email address, dividing the ASCII value by that value plus one, and storing the first six decimal positions.

6. The system of claim 5 wherein the final number is a result of the combination of the first and second parts.

7. The system of claim 1 wherein the merge/purge operation provides a plurality of purged output lists.

8. The system of claim 7 wherein each of the purged recorded data output lists are retransmitted to each respective list maintainer.

9. The system of claim 8 wherein match and identification code data representing names and addresses are supplied to the merge/purge operation without supplying actual address data.

10. A merge/purge system for eliminating duplicate mailings from maintainers of lists of names and addresses comprising:
computer programming means for processing maintainers lists of names and addresses to establish a standard format to remove nonconforming addresses, including:
means applying a match code algorithm to assign a match code to each record of names and addresses on each list,
means applying a key code identification number to identify the source of each record, and
a central merge/purge processor receiving said match and key codes from said lists and removing duplicate information based upon said codes to provide purged output lists data back to said maintainers lists,
said computer programming means processing said purged output lists data from said maintainers lists to match back unduplicated match codes to the original lists of names and addresses,
said lists maintainers transmitting mailings to the purged lists of names and addresses.

11. The system of claim 10 wherein the addresses are email addresses.

12. A method for eliminating duplicate mailings from maintainers lists of names and addresses comprising:
processing the lists from each maintainer through a computer software program utilizing the following match code algorithm to assign a match code to each record of names and addresses on each list to remove nonconforming addresses,
```
SECTION: Sum by ASCII Value in the Email divided by its position.
If (int_error_ indicator = False) Then
  dbl_prior = 0
  str_cmc = “ ”
  str_cmc = Ucase(Mid(str_irecord, intEmailpos, intEmaillen)
  For int_loop = 1 To Len(Trim(str_cmc))
    dbl_currentvalue = 0
    dbl_currentvalue = Asc(Mid(str_cmc, int_loop 1) / int_loop
    dbl_ prior = dbl_ prior + dlb_currentvalue
  Next
  ′str_sectional = Mid(Str(dbl_prior) + “.000000”, Instr(Str(dbl_{—}
  prior), “.”) + 1,6)
  str_sectional = Mid(Mid(Str(dbl_prior), InStr(Str(dbl_prior),
  “.”) + 1, 6) + “000000”, 1, 6)
SECTION: Sum the series a/b + b/c + c/d . . .
  Int_numerator = 0
  dbl_prior = 0
  int_numerator = Asc(Mid(str_cmc, 1, 1)
  For int_loop = 2 To Len(Trim(str_cmc))
    dbl_currentvalue = 0
    dbl_currentvalue = int_numerator / Asc(Mid(str_cmc,
    int_loop, 1))
    dbl_prior = dbl_prior + dbl_currentvalue
    int_numerator = Asc(Mid)str_cmc, int_loop, 1))
  Next
  ′str_section2 = Mid(Str(dbl_prior) + “.000000”,
  InStr(Str(dbl_prior), “.”) + 1, 6)
  str_section2 = Mid(Mid(Str(dbl_prior), InStr(Str(dbl_prior),
  “.”) + 1, 6) + “.000000, 1, 6)
SECTION: Build Output Record.
    str_orecord = “ ”
    str_orecord = str_orecord & Mid(str_section1 & str_section2
    & Space(12), 1, 12)
    str orecord = str_orecord & Mid(str_irecord, intPINpos,
    intPINlen)
    If (intKeypos > 0 Or intKeylen > 0)Then
      str_orecord = str_orecord & Mid(Mid(str_irecord, intKeypos,
      intKeylen) & Space (12), 1, 12)
Else
  str_orecord = str_orecord & Space(12)
End If
str_orecord = str_orecord & Mid(frmEncipher.txtjobno.Text &
Space(8), 1, 8)
str_orecord = str_orecord & “X”
Print #2, st_orecord
frmEncipher.txtocount.Text = frmEncipher.txtocount.Text +1
Else
  Print #3, str_irecord
End If
```
transmitting the lists processed by said algorithm back to the lists maintainers, and transmitting mailings from the list maintainers to the remaining lists of names and addresses.
